(19) United States
(12) Patent Application Publication
(10) Pub. No.: US 2006/0039634 A1
(43) Pub. Date: Feb. 23, 2006

(54) Fluid dynamic bearing motor attached at both shaft ends

(75) Inventor: Yoshikazu Ichiyama, Kyoto-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kura Laboratories Corporation, Kyoto-city (JP)

(21) Appl. No.: 11/203,152

(22) Filed: Aug. 15, 2005

Related U.S. Application Data
(63) Continuation-in-part of application No. 11/109,691, filed on Apr. 20, 2005.

(30) Foreign Application Priority Data
Aug. 20, 2004 (JP) JP2004-240563
Jan. 6, 2005 (JP) JP2005-001089
Jan. 28, 2005 (JP) JP2005-020873
Mar. 8, 2005 (JP) JP2005-063232
Jun. 14, 2005 (JP) JP2005-173103

(51) Int. Cl. F16C 32/06

(52) U.S. Cl. 384/100

(57) ABSTRACT

A fixed shaft type fluid dynamic bearing motor having two interfaces of a lubricant at least, in which a channel leading from near the outer region of a rotating sleeve top end to near the periphery of the bottom of the sleeve is formed in the sleeve. The lubricant near the outer region of a rotating sleeve top end is thrown out into the channel by centrifugal force, and further conveyed to near the periphery of the bottom of the sleeve by centrifugal force and/or by slanted channel in circumferential direction. A dynamic-pressure generating groove for pumping the lubricant toward the top end of the sleeve is formed between the fixed shaft and the sleeve. The dynamic-pressure generating groove and the centrifugal force cause the circulation of the lubricant, thereby sealing the lubricant. According to the invention, axial space smaller than that of tapered seals can be utilized to achieve a low-profile recording disk drive.

This is a continuation-in-part application of Ser. No. 11/109,691 filed on Apr. 20, 2005. The entire content of the application is hereby incorporated by reference.

### BACKGROUND OF THE INVENTION

1. Field of the Invention

The invention relates to a fluid dynamic bearing motor for a recording disk drive, and more particularly to a fluid dynamic bearing motor attached at both shaft ends (a fixed shaft type fluid dynamic bearing motor) which uses a novel lubricant sealing structure as an alternative to conventional tapered seals.

2. Description of the Related Art

The dominant bearing structure in conventional fluid dynamic bearing motors for magnetic disk drives (HDDs) has been a rotating shaft structure in which a lubricant and air form only a single interface to facilitate sealing in the lubricant. However, such fluid dynamic bearing is suffering from a number of disadvantages, for example, it could be sensitive to external vibration, imbalances and shock.

A desirable solution to this problem would be to have the spindle motor attached to both the base and the top cover of the disk drive housing. This would increase overall drive performance. A motor attached at both ends is significantly stiffer than a rotational shaft bearing. And also, the existence of the motor shaft that supports the top cover of the housing should be big advantage for the extremely small disk drive.

All of the known fluid dynamic bearing designs for a motor attached at both ends has not been easy to realize. The reason for this is that in order to have top cover attachment, the motor and specifically the bearing would need to be open on both ends. Opening a motor at both ends greatly increases the risk of lubricant leakage out of the fluid dynamic bearing. This leakage is caused by, among other things, small differences in net flow rate created by differing pumping pressures in the bearing. If all of the flows within the bearing are not carefully balanced, a net pressure rise toward one or both ends may force fluid out through the capillary seal. Moreover, due to manufacturing imperfections of the bearing, the gap in the bearing may not be uniform along its length and this can create pressure imbalance in the bearing and hence, cause leakage when both ends of the fluid dynamic bearing are open. The net flow due to pressure gradients in a bearing has to be balanced by all the bearings individually for the fluid to stay inside the bearing. Any imbalances due to pumping by the grooves of the bearings will force the fluid out of the capillary until the meniscus at one end moves to a new equilibrium position.

Nevertheless, most of the fluid dynamic bearing motors fixed or attached at both ends achieved in the past are for large-sized structures which are adapted to carry a number of magnetic disks for high speed rotation. Thus, it is difficult to employ the structure of these motors for low profile drives which carry and drive no more than two small magnetic disks or the like.

More specifically, the fluid dynamic bearing motors fixed or attached at both ends have many parts arranged in the axial direction such as described in U.S. Pat. No. 5,516,212,—in which having two thrust plates. Thus, if such structure is simply miniaturized for use in a small sized motor, the same arrangement cannot secure the span between the upper and lower radial bearings, failing to maintain low non-repetitive runout during rotation. Above all, the greater number of parts makes cost reduction difficult.

Present applicant formerly applied the fixed shaft type fluid dynamic bearing motor that has single thrust bearing with magnetic attracting means. That is suitable for low profile HDDs, however it cannot support heavy load, multiple disks. Thereby the fixed shaft type fluid dynamic bearing motor that does not apply the magnetic attractive means is considered.

For the fixed shaft type fluid dynamic bearing motors that are applicable to low-profile HDDs, Japanese Laid-open Patent Publications No. 2003-153484 and No. 2004-204942 are proposed. Both proposals have two thrust bearings at the both ends of radial bearing, however their bearing structure have the possibility of lubricant leakage because of dimensional inperfections of the bearing part or the bearing gap gradient whcih may occur in mass production stage. The lubricant in the lower thrust bearing section may leak out by centrifugal force in the former proposal. And also its radial span should be short because of many parts along the shaft, then it cannot achieve low non-repetitive runout. The later proposal has the defect that the bearing loss becomes large because of large radial bearing radius.

Another proposal for the fixed shaft type fluid dynamic bearing motors that are applicable to low-profile HDDs is U.S. Pat. No. 5,533,811 (FIG. 14(b) illustrates its simplified diagram of bearing structure). Considering the structure (FIG. 14(b)) that has two thrust bearings 141, 142 and the lubricant reservoir 146 at the lower outside peripheral of the sleeve with the communication channel 143 between outside region of two thrust bearings 141, 142, it cannot hold the lubricant in upper thrust bearing region 141. The lubricant in upper thrust bearing region 141 will move to the outside reservoir 146 by the centrifugal force. The bearing structure shown in FIG. 14(a) of U.S. Pat. No. 5,876,124 successfully holds the lubricant in the upper thrust bearing region 141, the lubricant in upper and lower lubricant reservoirs 144, 145 adds pressure on the lubricant in outer region of thrust bearings 141, 142 and the communication channel 143 exploiting centrifugal force.

The tapered seal structure widely used in the lubricant sealing structures of the fluid dynamic bearing motors also puts a strong constraint on realization of low-profile HDDs.

The tapered seal is a method of sealing which utilizes the surface tension of the lubricant. It is generally desirable that the tapered seal have an opening angle of 10 degrees or less, in view of sealing strength.

The tapered seal appropriately has a maximum gap of 0.3 millimeters or so. Even if the dimensional precision of the individual parts are increased to suppress the maximum gap to 0.2 millimeters, the tapered seal has a total length of 1.1 millimeters or more, given the opening angle of 10 degrees.

It can be said that, in order to achieve an HDD fluid dynamic bearing motor having a thickness of no greater than 3 millimeters or so, compromises must be made in various respects—including the sealing of the lubricant—despite an awareness of inadequacies.

### SUMMARY OF THE INVENTION

Thus, it is an object of the present invention to provide a fixed shaft type fluid dynamic bearing structure suitable for use in low profile motor for driving a few magnetic disk or the like at high precision.

Another object of the present invention is to provide a fixed shaft type fluid dynamic bearing motor with its shaft attached or fixed at its both ends, with a reliable lubricant sealing structure in which the bearing is open at both the upper and lower ends and ensuring highly precise rotational function.

A further object of the present invention is to provide a fluid dynamic bearing motor which has a single conical bearing surface and a thrust bearing surface, and suitable for low profile recording disk drive.

Yet further object of the present invention is to provide a fluid dynamic bearing motor which has a cylindrical radial bearing and two thrust bearings, and suitable for low profile recording disk drive.

These and other objectives of the invention are achieved by a fluid dynamic bearing motor attached at both ends according to the present invention. It comprises at least:
a fixed shaft;
a rotary member including a sleeve which is rotatably fitted on the shaft with a small gap therebetween;
a first annular member fixedly provided to oppose a top end of the sleeve with a gap;
a second annular member fixedly provided to oppose a bottom end and a lower periphery of the sleeve with a gap;
a lubricant lying in the gaps between the sleeve and the shaft, and between the sleeve and the first annular member, and between the sleeve and the second annular member continuously, and having at least two interfaces with air near the upper region of the sleeve and on the lower portion of outer periphery of the sleeve; and
a channel formed in the sleeve and having an intake portion near the portion of the sleeve adjacent to the outer region of the first annular member and an outlet portion near the periphery of the bottom end of the sleeve; and
at least two groups of dynamic pressure generating grooves for supporting the rotary member in a floated condition due to pressure partially increased in the lubricant by the grooves, one of the groups being formed on either of the upper surface of the sleeve and the first annular member and the other being formed on either of the inner surface of the sleeve and a surface confronting thereto; and
lubricant pressure adjuster for adjusting the outward lubricant pressure occurring in the channel around the outlet portion of the channel and/or in the channel.

According to another aspect of the present invention,
parameters of the lubricant pressure adjuster are determined such that the lubricant interface resides in the channel and the lubricant stays continuously from the outlet portion to the interface, and;
   one of the groups of dynamic pressure generating grooves formed on either of the confronting surfaces of the sleeve and the shaft or the second annular member are asymmetric herringbone grooves or spiral grooves to pump lubricant upward toward the outer end of the first annular member, so that the lubricant is thrown out into the intake portion of the channel by centrifugal force near the outer region of the first annular member, and is conveyed from the intake portion to the outlet portion through the channel with the lubricant being discontinuous.

According to another aspect of the present invention, the fluid dynamic bearing motor has discontinuously filled lubricant from the channel intake to the channel outlet. It makes easy that the fluid pressure diagram becomes continuous around the channel outlet so as to stabilize the fluid interface with air move.

FIG. 15 shows a sealing model of the fluid dynamic bearing motor according to the present invention. In the model, lubricating fluid is retained on outer periphery of the sleeve and in channel 151, 152 respectively. 153 represents pressure generating groove. Surface tension forces 156, 157 at the lubricating fluid accumulating portions 151, 152 are drawing respectively the lubricating fluid upwardly, and pressure generating grooves 153 is drawing the lubricating fluid inversely, and drawn-in lubricating fluid by pressure generating groove 153 is thrown out into the accumulating portion of the channel 152 by the centrifugal force at the sleeve top 154. And total quantity of the lubricating fluid in the lubricating fluid accumulating portions 151, 152 and in the bearing region that has groove 153 is constant. In this sealing model, the centrifugal force acting on the lubricating fluid in the channel should be a major cause to make the sealing unstable. The present invention employs lubricant pressure adjusters to ease and to adjust the fluid pressure around the channel outlet, lubricant pressure adjusters are, for example, gap diminishing region in the channel, pressure generating grooves between the channel outlet and the fluid boundary at the sleeve outside, means for pressing the lubricating fluid from the channel outlet toward the intake.

According to another aspect of the present invention, flow resistance from the thrust bearing region between the first annular member and the sleeve top toward the channel intake is large enough so as to make the lubricant stay in the thrust bearing region.

According to another aspect of the present invention, the fluid dynamic bearing motor realizes perfect sealing structure of the lubricant by circulation of the lubricant due to centrifugal force. During rotation of the motor, the lubricant which is conveyed to the outer region of of the sleeve top by the pressure generating groove is thrown out into the channel in the sleeve. The channel desirably has a gap portion as small as the lubricant can be retained therein by surface tension. At rest of the motor, the lubricant is absorbed and retained in the channel. While the dimension of the gap of the channel may be as small as the lubricant can be retained by surface tension, and the dimension varies depending on both the viscosity of the lubricant and the surrounding materials. An appropriate value is no greater than 0.2 millimeters or so.

According to yet another aspect of the present invention, the fluid dynamic bearing motor eliminates the need for a long tapered seal near the top end of the sleeve. At rest of the motor, most of the lubricant is absorbed in the channel in the sleeve and during rotation, the lubricant is thrown out into the channel near the outer region of the sleeve top by centrifugal force.

According to a further aspect of the invention, the fluid dynamic bearing motor effectively avoids leakage of the lubricant. The lubricant pumping capability of the bearing groove, toward the sleeve top is set sufficiently higher to compensate for such problems as imperfections in the bearing groove, and the tilt of the gap in which the bearing groove lies.

In a further aspect of the invention, the fluid dynamic bearing motor also has the function of removing air bubbles in the lubricant. The lubricant is influenced by the centrifugal force and is thrown out into the channel near the outer region of the sleeve top. Meanwhile, the bubbles are released to the air since no centrifugal force acts thereon.

According to another aspect of the embodiment, the fluid dynamic bearing motor includes the fixed shaft of a conical or truncated conical shape with its diameter reducing toward the top end. The sleeve has a conical concave opening to fittingly receive the shaft. A first annular member is fixed to the shaft and opposing a top end of the sleeve with a gap. One or more sets or groups of dynamic-pressure generating grooves are formed on either of the shaft and the sleeve, with at least one of the dynamic-pressure generating grooves having capability of pumping the lubricant toward the top end of the sleeve. An asymmetric herringbone groove or a spiral groove to pump inward is formed on either of the first annular member and the sleeve top. This type of motor is suited for low profiles while securing the space for the dynamic-pressure generating grooves.

According to yet another aspect of the embodiment, the fluid dynamic bearing motor includes a fixed shaft of a cylindrical shape and a sleeve has a cylindrical opening to rotatably and fittingly receive the shaft. The sleeve opposes the first and the second annular members at its top and bottom ends orthogonal to the shaft respectively. Dynamic-pressure generating grooves are formed on either one of the outer periphery of the shaft and the inner periphery of the sleeve, and either one of the first and the second annular members and the opposing surfaces, respectively. At least the dynamic-pressure generating groove formed on either the lower end of the sleeve or the surface opposing thereto is formed as an asymmetric herringbone groove or a spiral groove having capability of pumping the lubricant radially inward.

### BRIEF DESCRIPTION OF THE DRAWINGS

In the accompanying drawings:

FIG. 1 is a vertical sectional view of a fixed shaft type fluid dynamic bearing motor which is a first embodiment of the present invention;

FIG. 2 is an enlarged perspective view of inner and outer cylindrical or barrel members which compose a sleeve shown in FIG. 1;

FIG. 3 is an enlarged vertical sectional view of the bearing part of FIG. 1;

FIG. 4 is an enlarged vertical sectional view of the bearing part of FIG. 1;

FIGS. 5(a), 5(b) illustrate in enlarged modeled forms the portion around the channel outlet and sleeve bottom of FIG. 1 and the lubricant pressure diagram;

FIG. 6 is a vertical sectional view of a fluid dynamic bearing motor which is a second embodiment of the present invention;

FIG. 7 is an enlarged perspective view of inner and outer cylindrical or barrel members which compose a sleeve shown in FIG. 6;

FIG. 8 is an enlarged vertical sectional view of the upper bearing part of FIG. 6;

FIGS. 9(a), 9(b) illustrate in enlarged modeled forms the portion around the channel outlet and sleeve bottom of FIG. 6 and the lubricant pressure diagram;

FIG. 10 is a vertical sectional view of a fluid dynamic bearing motor which is a third embodiment of the present invention;

FIG. 11 is an enlarged perspective view of inner and outer cylindrical or barrel members which compose a sleeve shown in FIG. 10;

FIG. 12 is a vertical sectional view of a fluid dynamic bearing motor which is a fourth embodiment of the present invention;

FIGS. 13(a) and 13(b) are sectional views of a low-profile recording disk drive which is a fifth embodiment of the present invention.

FIGS. 14(a) and 14(b) are sectional views of simplified diagram of U.S. Pat. No. 5,876,124 and 5,533,811.

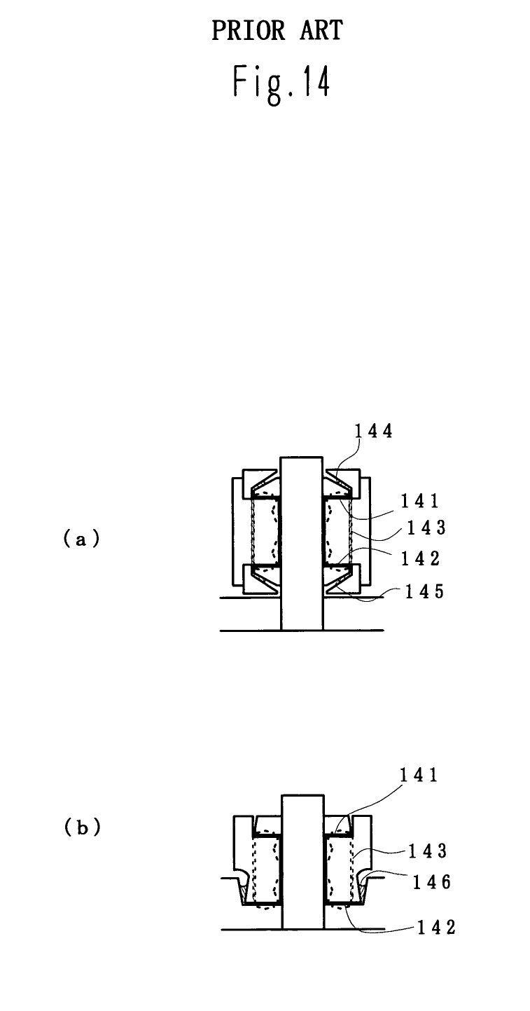

FIG. 15 illustrate a lubricating fluid sealing model of the present invention;

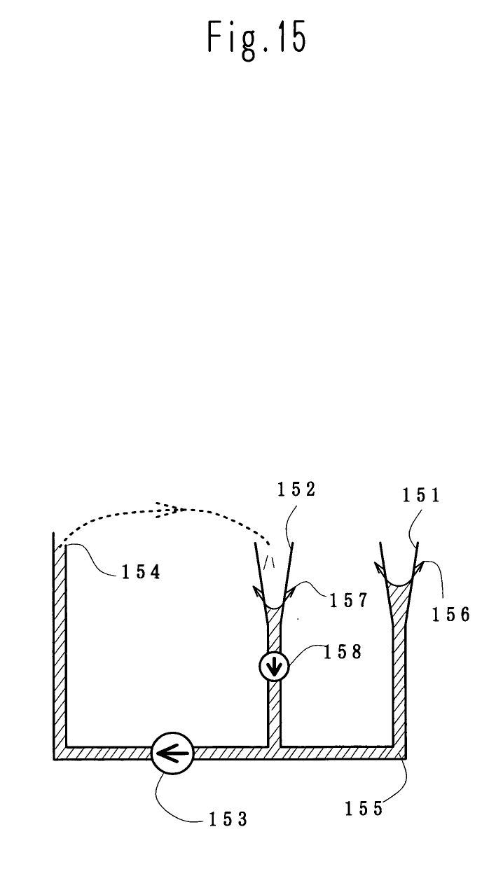

### DETAILED DESCRIPTION OF THE PREFERRED EMBODIMENTS

Hereinafter, embodiments, operating principles of a fluid dynamic bearing motor attached at both shaft ends according to the present invention will be described with reference to the drawings.

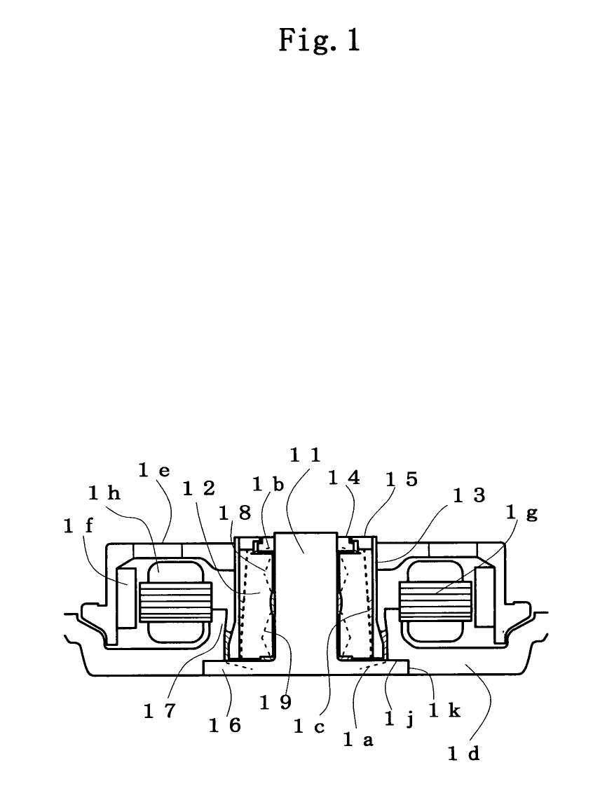

FIG. 1 is a vertical sectional view of a fixed shaft type fluid dynamic bearing motor which is a first embodiment of the present invention.

A fixed shaft 11 is a T-shaped cylindrical shaft which is composed of a cylindrical shaft and a flange 16. The sleeve, which rotatably fits to a T-shaped cylindrical shaft 11, is composed of an inner cylinder 12 and an outer cylinder 13. The upper and lower end surfaces of the inner cylinder 12 are opposing the first annular member 14 which is fixed to the shaft 11 and the flange 16 with small gap respectively.

The second annular member specified in claim 1 corresponds to the flange 16 and the part 17 of the base plate 1d (hereinafter, referred to as an annular member 17). The numeral 1c represents channels formed in the sleeve and having an intake portion near the outer region of the first annular member 14 and an outlet portion near the periphery of the bottom end of the sleeve. A lubricant is continuously filled into the gap between the shaft 11 and the inner cylinder 12, and the gap between the inner cylinder 12 and the first annular member 14, the flange 16, and the gap between the periphery of the outer cylinder 13 and the annular member 17. The interfaces of the lubricant with the air lie at outer region of the first annular member 14, in the channel 1c and on the periphery of the outer cylinder 13 respectively.

The shaft 11 is positioned to a base plate 1d by using the flange 16 radial side 1k, and is fixed to the base plate 1d with the flange 16 axial side 1j being secured with a suitable adhesive strength. The numerals 1f, 1e, 1g, and 1h represent a rotor magnet, a hub which supports one or more magnetic disks, a stator core, and a coil, respectively.

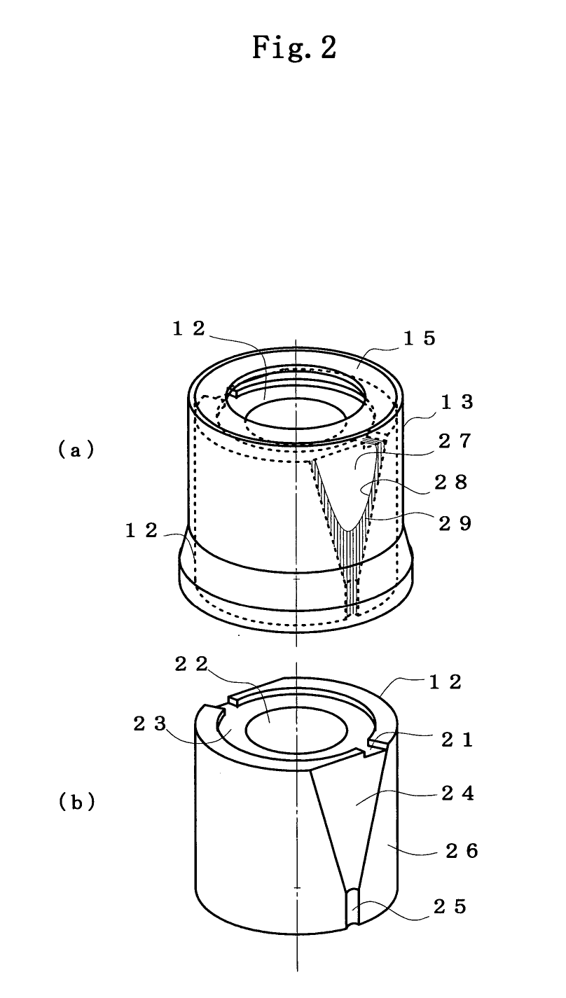

FIG. 2 is a perspective view of the outer cylinder 13 and the inner cylinder 12 that constitute the sleeve of the fluid dynamic bearing motor shown in FIG. 1. FIG. 2(b) shows the inner cylinder 12. FIG. 2(a) shows the combination of the inner cylinder 12, the outer cylinder 13, and the cover 15. The outer cylinder 13 is formed by press molding from Aluminium plate. And the inner cylinder 12 is machined from SUS material.

The inner cylinder 12 has two slanted flat surfaces 24 and two concave grooves 25 on its outer surface to form channels 1c with the outer cylinder 13. The numeral 22 represents a through hole in which the shaft 11 is fitted loosely, the numeral 23 represents a thrust bearing surface confronting the first annular member 14, the numeral 21 represents an intake of the channel 1c, and the numeral 26 represents an outer surface of the inner cylinder 12 besides the slanted flat surface 24 and the concave groove 25.

The outer surface of the inner cylinder 12 is fitted to the inner surface of the outer cylinder 13 and fixed by bonding at the outer surface 26 of the inner cylinder 12. The grooves 25 are given a depth of, for example, around 20 micrometers so that the formed channel 1c has the capability of retaining the lubricant by surface tension. The slanted flat surface 24 and the outer cylinder 13 form the gap diminishing region where the gap width becomes smaller toward the bottom. A hatched area shows the lubricant staying zone 29, numeral 27 shows air zone, numeral 28 shows the lubricant interface with the air.

The inner cylinder 12 can be fabricated by molding of sintered material or resin also. In that case, the slanted flat surfaces 24 and the grooves 25 are formed by molding die at the same time, production cost will be reduced. The spiral groove 1b on the surface of the first annular member 14, can be formed on the inner cylinder 12 top by molding die at the same time. Also, when the outer cylinder 13 is formed by press molding, pits and projections may be formed simultaneously in and on the inner periphery of the outer cylinder 13 to constitute the channel 1c.

A cover 15 shown in FIG. 1 and FIG. 2(a) is fixed on the top of the outer cylinder 13 and is opposing to the first annular member 14 with a small gap. The small gap makes fluid flow resistance toward outside large enough to provide the effect that the vapor pressure of the lubricant within the channel 1c is increased to suppress the evaporation of the lubricant.

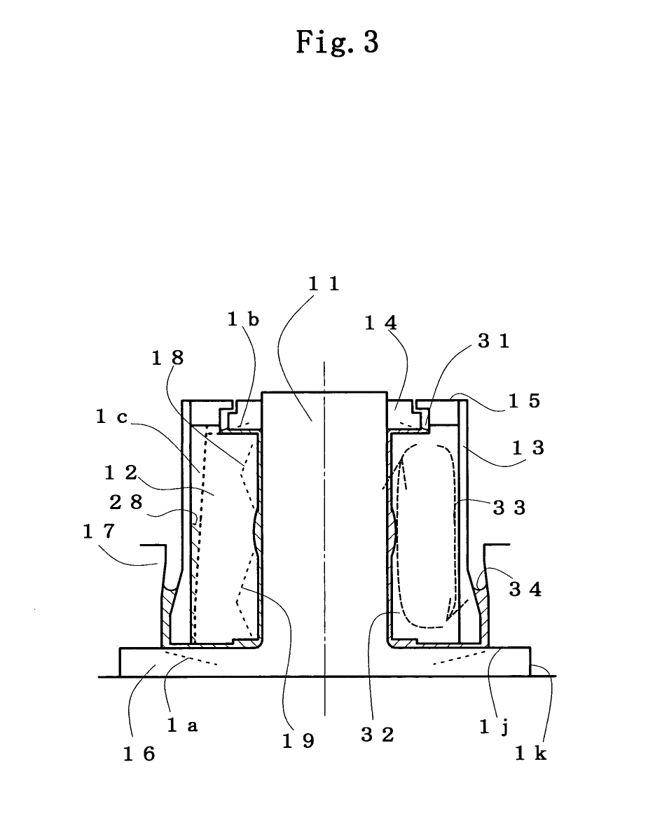

FIG. 3 is an enlarged view of the bearing part of the fluid dynamic bearing motor shown in FIG. 1. Description will now be given of the operating principle. For convenience of understanding, FIG. 3 shows the channel 1c and the grooves 18, 19, 1a, and 1b in the left half alone, while the directions of movement 32 and 33 of the lubricant are shown by dotted lines in the right half.

The flange 16 and the first annular member 14 has pump-in spiral groove 1a, 1b respectively. The inner cylinder 12 has two asymmetric herringbone grooves 18, 19 that pumps the lubricant toward each adjacent spiral grooves. The herringbone grooves are each made of a pair of spiral grooves for pumping the lubricant toward each other. When the pumping capabilities of the lubricant are configured unevenly, these spiral grooves exert the lubricant pumping capability in one direction as an asymmetric herringbone groove. The herringbone groove 18 and 19 are set to have a lubricant pumping capability directed toward upper and lower respectively. The numeral 34 represents the lubricant interface with air at the lower outside of the outer cylinder 13.

The spiral groove 1a and the asymmetric herringbone groove 18 have the lubricant pumping capability toward the first annular member 14, and the spiral groove 1b and the asymmetric herringbone groove 19 have the lubricant pumping capability toward the inverse direction. However these grooves parameter are set as that the lubricant will be always pumped toward outer region of the first annular member 14 during rotation. Then the lubricant continuously flows as shown by a dotted line 32, and the lubricant is thrown out into the channel 1c by the centrifugal force acting directly on the lubricant at the outer region of the first annular member 14. The thrown out lubricant joins with the lubricating fluid at the boundary 28 and then is lead to the channel outlet. The dotted line 33 shows the direction of flow of the lubricating fluid within the channel 1c.

Conventional taperd seal structure occupies long space along the axtial direction around the first annual member 14. During rotation, the lubricant is thrown out into the channel 1c by centrifugal force as explained above, this embodiment allows effective sealing of the lubricant, with an axial space shorter than in conventional tapered seal structures.

There is the lubricant interface with air around the outer region 31 of the first annual member 14 when at rest. During rotation, the lubricant flows along the top of the inner cylinder 12 toward the channel 1c. The centrifugal force acts on the lubricant directly, and the intake of the channel 1c locates at outer region of the first annular member 14, then the driven lubricant esasily flows into the channel 1c.

During rotation, the pump-in spiral groove 1b and the asymmetric herringbone groove 18 press the lubricant toward each other to increase the pressure of the lubricant at the top end of the inner cylinder 12. Also the pump-in spiral groove 1a and the asymmetric herringbone groove 19 press the lubricant toward each other to increase the pressure of the lubricant at the bottom end of the inner cylinder 12. And then the inner cylinder 12 is sustained without contact. However, the thrust bearing region between the first annular member 14 and the top end of the inner cylinder 12 has partially opened, the lubricant tend to leak out outward. Negative pressure region may appear in around outer region of the spiral groove 1b and air bubbles may stay there.

This embodiment sets parameters as that the net lubricant pumping capability of the grooves makes the lubricant flow continuously outward at the top of the inner cylinder 12. Thus air bubbles are prevented to enter into and the function of the spiral groove 1b can be maintained. Also, the narrow intake 21 of the channel 1c makes the flow resistance high and can hold the lubricant at the thrust bearing region. Moreover, the diameter of the spiral groove 1b that is a little larger than that of a conventional groove designed considering the closed thrust bearing condition also can compensate for degradation of the spiral groove function.

The foregoing structure for sealing the lubricant also has the function of removing air bubbles. More specifically, if bubbles exist between the shaft 11 and the inner cylinder 12, they are conveyed to the outer region of the first annular member 14 by the flow of the lubricant shown by the dotted line 32. In the intake portion, the lubricant experiences the centrifugal force and is thrown out as shown by the dotted line 33. Meanwhile, the bubbles are released to the air since no centrifugal force acts thereon.

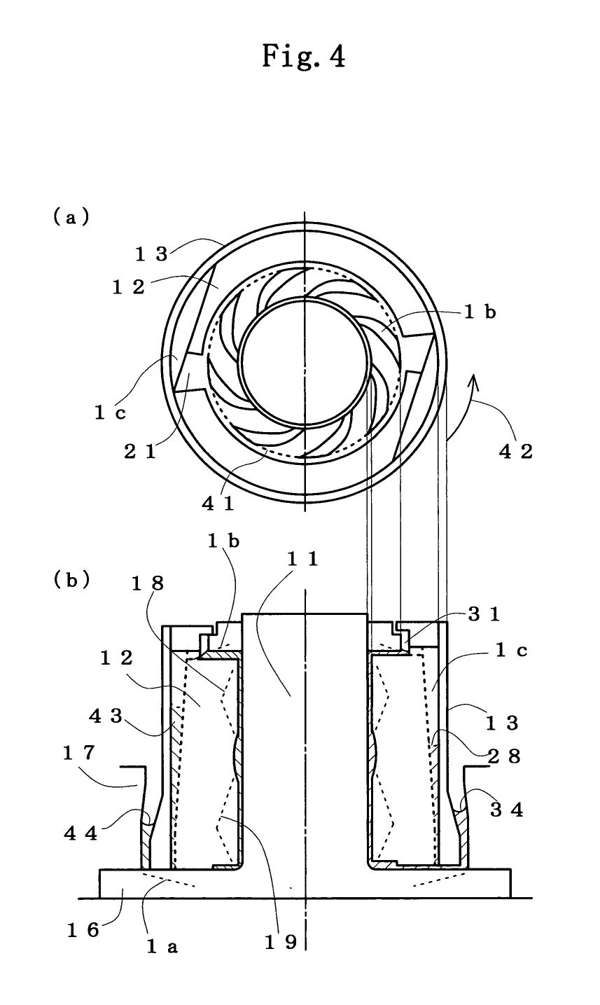

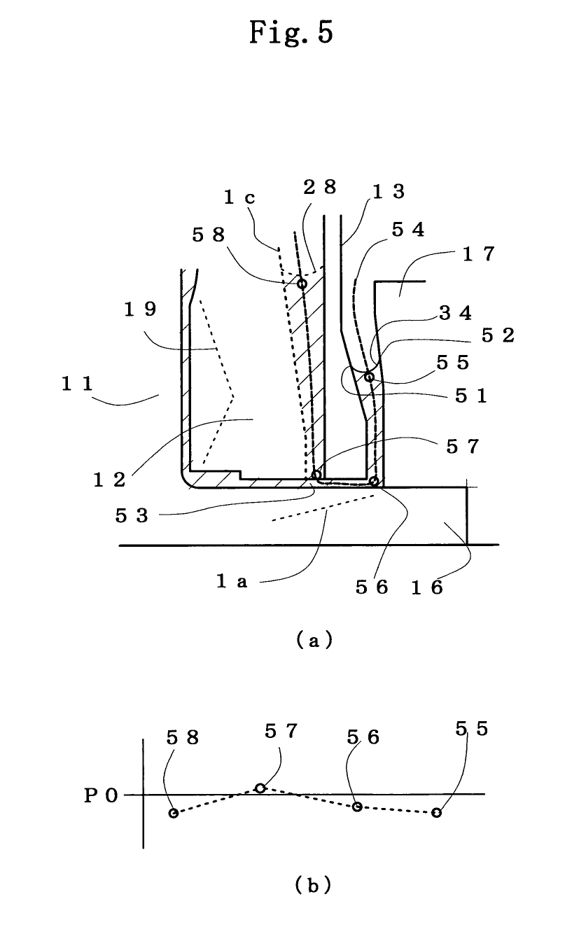

The behavior of the lubricant at rest, and during rotation, will be described further with reference to FIGS. 4 and 5. FIG. 4(a) shows the top view of the inner cylinder 12 and FIG. 4(b) shows the cross section of the bearing part as FIG. 3. The left half and the right half of the diagram show the state at rest and during rotation respectively. Numeral 42 shows the direction of the sleeve rotation.

The left half of the diagram in FIG. 4(b) shows the state at rest, in which part of the inner cylinder 12 is in contact with the flange 16. The right half shows the state of during rotation, in which the inner cylinder 12 floats without contact with the shaft 11 and the flange 16. What is worth noting in the left and right halves of FIG. 4 (b) is the positions of the lubricant. In the left half of the diagram which shows the state at rest, the lubricant lies in the channel 1c (designated by the numeral 43) and between the shaft 11 and the inner cylinder 12. In the right half of the diagram which shows the state of during rotation, the lubricant lies between the shaft 11 and the inner cylinder 12, and between the outer cylinder 13 and the annular member 17. The lubricant interface position in left and right half of the diagram is different as shown by numerals 44 and 34.

FIG. 4(a) shows the spiral groove 1b within a circle 41 that corresponds to the location of the first annular member 14. The spiral groove 1b itself is on the first annular member 14, it is shown on the top of the inner cylinder 12 as easily understood the relative location.

The amount of the lubricant to be drawn into the channel 1c at rest depends on the capacity of the channel 1c. The volume of the channel 1c can be adjusted to alter the amount of the lubricant to reside between the outer cylinder 13 and the annular member 17 at rest. The amount also depends on the gap inside the channel 1c, and the gap between the outer cylinder 13 and the annular member 17. At the start of rotation, the lubricant is supplied from the channel 1c, yet with some time delay which might cause insufficient lubrication. Thus, the foregoing size specifications are adjusted so that an appropriate amount of lubricant always resides between the outer cylinder 13 and the annular member 17, even at rest.

In this embodiment, the lubricant is forced to circulate. And at the outer region of the first annular member 14, the lubricant is exposed in air and thrown out in the intake of the channel 1c by the centrifugal force and is further driven along the channel 1c by centrifugal force. So air bubbles should be released in that process. Exploiting air bubbles rejection function, filling the lubricant process can be simplified by eliminating the need for a vacuum process.

After fixing the shaft 11 at the base plate 1d, filling the lubricant will be finished by which a predetermined amount of lubricant is dropped into the assembly. Or following filling process is available; 1) to drop a predetermined amount of lubricant into the assembly before fixing the cover 15, 2) to fix the cover 15 on the outer cylinder 13. There is no problem to fix the cover 15 after filling the lubricant because the cover 15 does not contact with the lubricant. The lubricant will be allocated at proper place automatically during rotation.

The pressure distribution of the lubricant around the channel outlet during rotation of the motor, will be described further with reference to FIG. 5. The lubricant in the channel 1c is pushed outwardly by the centrifugal force. The gap diminishing region in the channel 1c and the part of spiral groove 1a functions as the lubricant pressure adjuster for adjusting the fluid pressure occurring in the channel. Radial thickness of the interface 28 region is so small that fluid pressure increase by the centrifugal force should be small. And also, the minimum gap width of the gap diminishing region can be around zero. Therefore surface tension force of the lubricating fluid in the gap diminishing region is enough to retain the lubricating fluid against the centrifugal force even when the sleeve rotates at high speed. The outlet 53 lies in the area of the spiral groove 1a as shown in FIG. 5(a). The part of the spiral groove 1a that is out of the outlet 53 functions as the lubricant pressure adjuster for adjusting the fluid pressure occurring in the channel 1c, change of lubricant pressure along the dotted line 54 is shown in diagram of FIG. 5(b). The horizontal axis indicates the location of points on the dotted line 54, and the vertical axis indicates the lubricant pressure with reference to the atmospheric pressure P0.

The fluid pressure at the point 55 inside of the interface 34 is lower than the atmospheric pressure P0, and the fluid pressure at the point 56 is slightly higher than the same by the centrifugal force. The fluid pressure at the point 58 inside of the interface 28 is lower than the atmospheric pressure P0, and the fluid pressure at the point 57 is increased from the point 58 by the centrifugal force. There is some possibility that the interface 28 is not clear enough, because the lubricating fluid is continiously flowing in. In this embodiment, the interface 28 is wide in circumferential direction enough to reduce the effect of flowing of the fluid into the interface 28.

The fluid pressure should be continuous as shown in FIG. 5(b) during rotation. When the quantity of the lubricant at outer periphery of the sleeve increases, the interface 34 moves outward, and then the fluid pressure at the point 55 becomes higher towards P0 because that a radius of the interface 34 curve becomes larger. While the lubricant in the channel 1c increases, the pressure difference between the points 58 and 57 also becomes larger. Accordingly, the quantity of the lubricant around the outlet 53 is properly divided in the channel 1c and at outer periphery of the sleeve as the fluid pressure is continuous as shown in FIG. 5(b).

When the lubricant pressure adjuster is not employed, the condition for stabilization of the lubricant around the outlet 53 is that the point 56 is positioned radially outward of the point 55 as the pressure at the point 56 becomes larger by the centrifugal force. Then there exists strict constraints about the outer cylinder 13 shape and dimensions. According to the present embodiment, the gap diminishing region in the channel 1c and the part of spiral groove 1a functions as the lubricant pressure adjuster, thereby ensuring flexibility of the design.

The distribution of lubricant pressure generated by the spiral groove 1a varies in circumferential direction according to lands and grooves of the spiral groove 1a area. Therefore it may cause periodical vibration as to the position of lubricant interface with air. In that case, following structures stabilize the movement of the lubricant interface thereby providing perfect sealing. A circular groove opposing to the channel outlet position can ease the circumferential pressure variation of the lubricant. And also the spiral groove 1a formed on the bottom surface of the sleeve add constant lubricant pressure toward the channel intake direction.

The fluid dynamic bearing motor of the present invention, is discontinuously filled with lubricant from the channel intake to the channel outlet. It facilitates the balancing of the fluid pressure around the channel outlet and contributes to the stable fluid sealing. In case that there is continuously filled lubricant in the channel, it is hard to balance the fluid pressure generated by the grooves and the centrifugal force with the pressure near the fluid interface during rotation.

This fixed shaft type fluid dynamic bearing motor should be used in high speed rotation field. The peripheral portion of the spiral groove 1a is where negative pressure can easily occur during high speed rotation. Countermeasures will now be described with reference to FIG. 5. While the spiral groove 1a pumps the lubricant radially inward, the radially-outward centrifugal force acting on the peripheral portion can lower the pressure of the lubricant to a negative pressure. This makes it easier for bubbles to reside. This embodiment makes optimization of the spiral groove 1a location and the peripheral shape of the outer cylinder 13 to prevent the appearance of the negative pressure region.

The numeral 51 represents an intersection of the outer cylinder 13 with the interface 34 between the lubricant with the air, while the numeral 52 represents an intersection of the annular member 17 with the interface 34. The portion of the lubricant interface 34 around the intersection 51 is moving rapidly with the outer cylinder 13, and the portion of the lubricant interface 34 around the intersection 52 is at rest with the annular member 17. In the present embodiment, the spiral groove 1a is given an outer diameter greater than the outer diameter of the outer cylinder 13, i.e., it is arranged radially outside the high-speed flow side (51) of the interface 34 of the lubricant. As shown enlarged view in FIG. 5(a), the lower periphery of the outer cylinder 13 reduces in diameter with an increasing distance from the bottom end to above, and the gap from the annular member 17 is increased gradually to form a tapered seal portion. This shape also enables to allocate the intersection 51 in smaller diameter side and easier to realize above condition.

Consequently, the centrifugal force acting on the lubricant that is rotating and flowing at high speed is integrated along the surface of the outer cylinder 13. The pressure of the lubricant reaches its maximum near the periphery of the bottom end of the outer cylinder 13. In this structure, the centrifugal force is then utilized to apply pressure to near the periphery of the spiral groove 1a, thereby avoiding the occurrence of negative pressure.

In the present embodiment, the channel 1c is formed as the gap between the inner cylinder 12 and the outer cylinder 13. Nevertheless, the inner cylinder 12 of the sleeve may be made of a porous material having a number of small gaps so that the small gaps form the channel 1c. A sintered alloy material may be filled into the outer cylinder 13 to form the inner cylinder 12, and to form the herringbone grooves 18 and 19 simultaneously.

Since small gaps also exist in the surface of the area where the herringbone grooves 18 and 19 are formed, the lubricant might permeate into the inner cylinder 12 through those gaps in the surface, possibly causing shortage of the lubricant in the herringbone groove 19. In this case, the small gaps in the surface of the inner cylinder 12, excluding near the interface with the outer cylinder 13, are filled with a resin having a high lubricity for caulking.

The novel lubricant sealing structure, of which the structure and principle of operation have been described in the present embodiment, is characterized in that the axial space necessary near the top end of the sleeve can be made smaller.

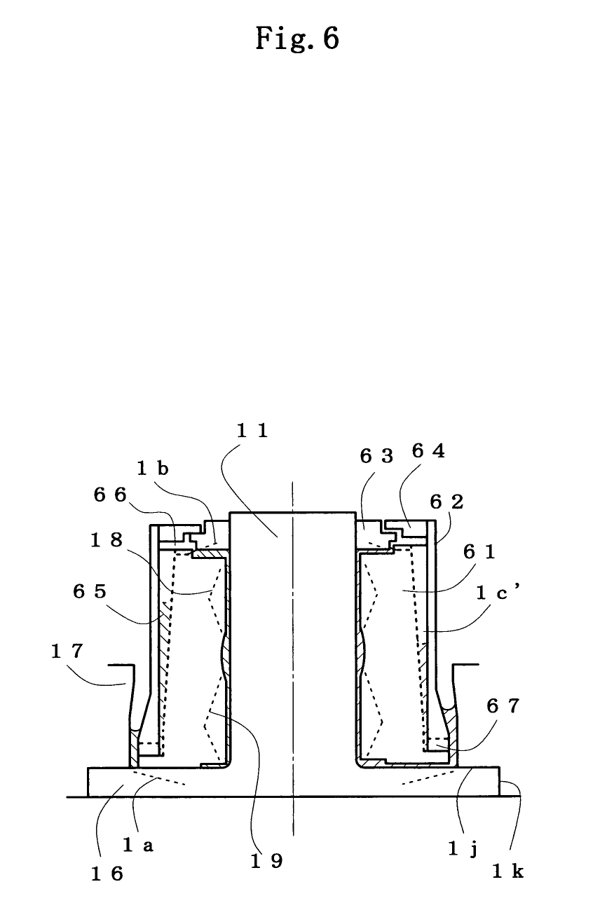

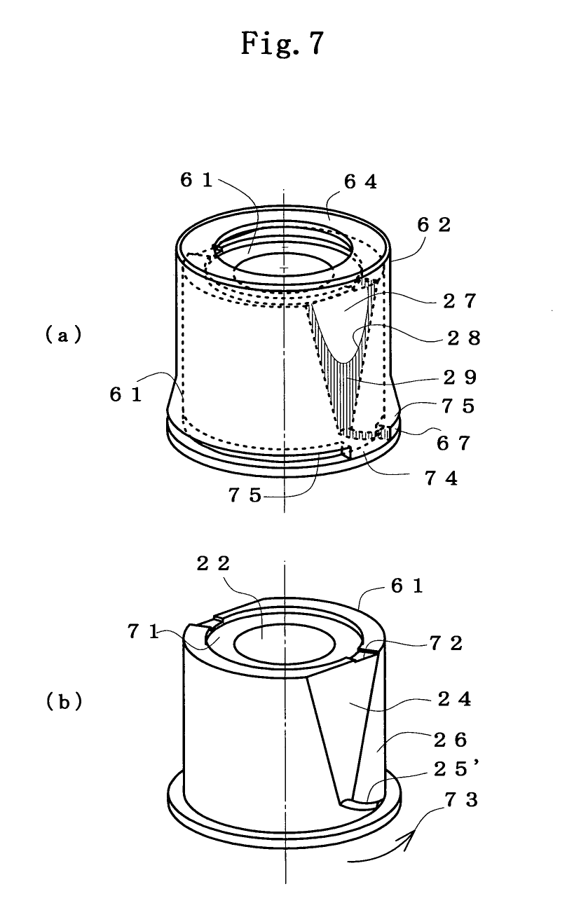

FIG. 6 shows a vertical sectional view of bearing in a second embodiment. This second embodiment changes the structures around the top of the sleeve, the first annular member, the cover and the channel in FIG. 1. Description will thus be concentrated on differences from the first embodiment shown in FIG. 1. The left half and the right half of the diagram in FIG. 6 show the state at rest and during rotation respectively as same as in FIG. 4(b). There are differences in the rotating part position and the lubricant interfaces with air. FIG. 7 shows a perspective view of the inner and outer cylinder and the cover in FIG. 6.

In FIG. 7(b), the inner cylinder 61 have annular concavity 71 (a thrust bearing surface) at its top fitting to the first annular member 63. The intake 72 of the channel 1c′ is concave groove extended from the annular concavity 71. Also the annular opening 66 is set as the gap between the cover 64 and the peripheral of the inner cylinder 61 top.

Grooves 25′ formed on the surface of the inner cylinder 61 is different from the groove 25 in its shape. The groove 25 is linear and the groove 25′ is spiral shape. The direction of the spiral shape groove 25′ is to press the lubricating fluid from the channel outlet toward the intake during rotation. Numeral 73 represents the direction of rotation.

FIG. 7(a) shows a perspective view of the combination of the inner cylinder 61 and the outer cylinder 62. Lower parts of the outer cylinder 62 have differnt length as shown in numerals 74, 75. Numeral 74 indicates a rear part, and numeral 75 indicates a front part regarding the channel outlet 67. The rear part 74 is an extended part of the outer cylinder 62, and it makes gap smaller between the outer cylinder 62 and the annular member 17. Therefore, the lubricating fluid is pressed into the channel outlet 67 during rotation.

During rotation, the lubricant will be always pumped toward the first annular member 63 as explained using FIG. 3. And the lubricant is thrown out into the channel 1c′ through the intake 72 by the centrifugal force. The position of the intake 72 is higher than the annular concavity 71, then the lubricant is thrown out into the channel 1c′ over a step between the intake 72 and the annular concavity 71. The lubricant stays in the depth as same as the step around the thrust bearing region constituted by the first annular member 63 and the inner cylinder 61 top.

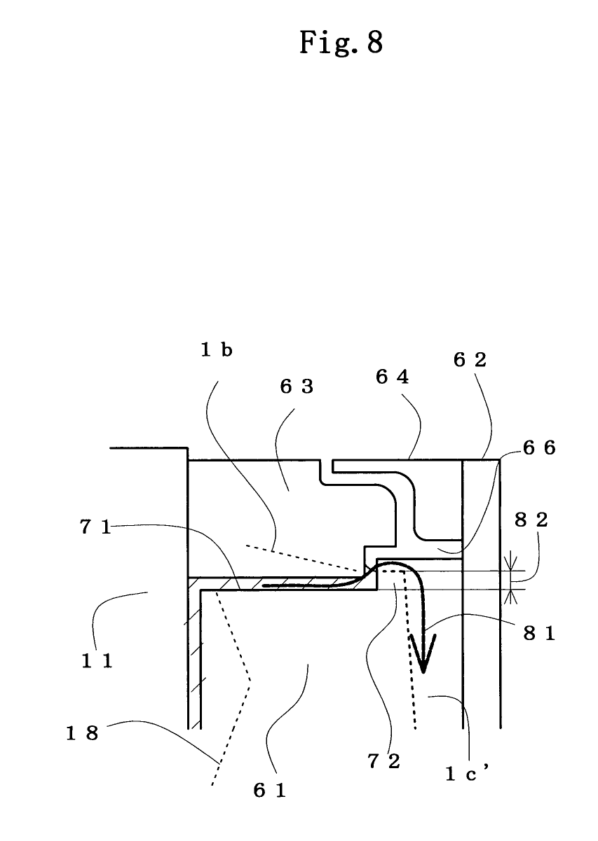

FIG. 8 shows an enlarged sectional view of the inner cylinder 61 top and the first annular member 63. Numeral 82 indicates the step between the intake 72 and the annular concavity 71, and numeral 81 indicates a flow line of the lubricant flowing over the step 82.

The gap between the annular member 63 and the annular concavity 71 during rotation is between several micron meters and around 20 micron meters. The step 82 is set to be an appropriate value more than 20 micron meters. Comparing to the first embodiment, it is much improved to secure the lubricant in the thrust bearing region.

The annular opening 66 is constituted by the gap between the cover 64 and the peripheral of the inner cylinder 62 top in axial direction. The opening gap is allocated bigger than the gap between the annular member 63 and the inner cylinder 62 top as to receive a lubricant spout when shocked.

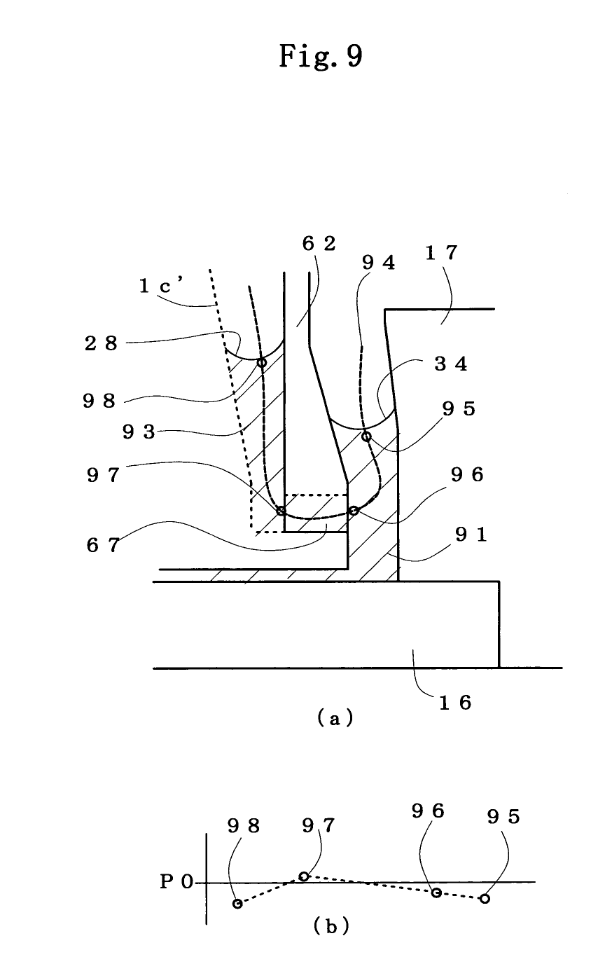

FIGS. 9(a) and 9(b) show the enlarged view of an accumulating portion of the lubricant at outer periphery of the sleeve and the gap diminishing region in the channel, and the lubricant pressure diagram. Numeral 91 indicates the lubricant at the outer periphery of the sleeve, numeral 67 indicates the outlet of the channel 1c′, and numeral 93 indicates the lubricant in the channel 1c′. Along the dotted line 94, the point 95 inside of the interface 34, the point 96 around the outlet 67, the point 97 close to the bottom of the channel 1c′, the point 98 inside of the interface 28 of the lubricant 93 are shown in FIG. 9(a). Fluid pressures at these points are indicated in FIG. 9(b). The horizontal axis means the location of points on the dotted line 94, and the vertical axis means the lubricant pressure referring the atmospheric pressure P0.

The fluid pressure at the point 95 inside of the interface 34 is lower than P0, and the fluid pressure at the point 96 is slightly higher than that by the centrifugal force. The fluid pressure at the point 98 inside of the interface 28 is lower than P0. The fluid pressure at the point 97 is increased by the centrifugal force acting on the lubricating fluid in the channel 1c′ from the point 98. Pressure difference between the points 97 and 96 is the effect of that the lubricating fluid is pushed from the channel outlet 67 during rotation.

The fluid pressure should be continuous as shown in FIG. 9(b) during rotation. When the quantity of the lubricant in the channel increases, the fluid pressure at the point 97 is increased. While the quantity of the lubricating fluid at outer periphery of the sleeve increases, the interface 34 moves outward, and then the fluid pressure at the point 95 becomes higher towards P0 because that a radius of the interface 34 curve becomes larger. Accordingly, the quantity of the lubricating fluid around the channel outlet 67 is properly divided in the channel and at outer periphery of the sleeve as the fluid pressure is continuous as shown in FIG. 9(b).

In the embodiment shown in FIGS. 6, 7, 8, and 9, the gap diminishing refion in the channel, slanted channel, and the structure to press the lubricating fluid from the channel outlet 67 are employed as the lubricant pressure adjuster for adjusting the outward/downward lubricant pressure occurring in the channel around the channel outlet. And the embodiment can seal the lubricant steadily even in case of higher rotational speed.

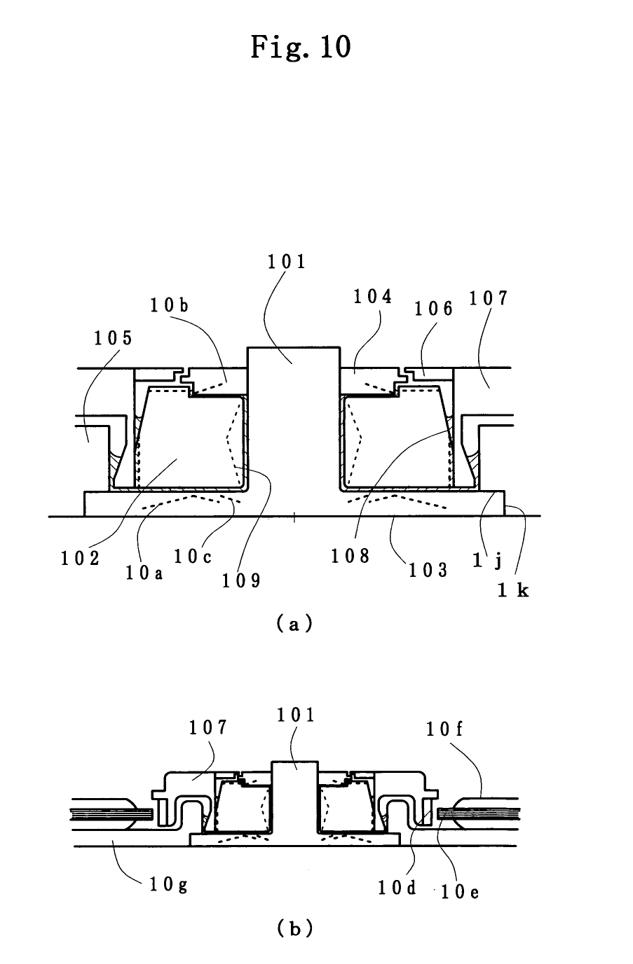

While the first and the second embodiments have dealt with an example of two radial bearings, a third embodiment shown in FIG. 10 will deal with an example of single radial bearing which is suitable for a lower profile HDDs.

A fixed shaft 101 is a T-shaped cylindrical shaft which is composed of a cylindrical shaft and a flange 103. The sleeve, which rotatably fits to a T-shaped cylindrical shaft 101, is composed of an inner cylinder 102 and a hub 107. The upper and lower end surfaces of the inner cylinder 102 are opposing the first annular member 104 which is fixed to the shaft 101, and the flange 103 with small gap respectively. The constitution around the inner cylinder 102 top is the same as that of the second embodiment as shown in FIGS. 6, 7, 8, and 9. The inner cylinder 102 has annular concavity at its top fitting to the first annular member 104.

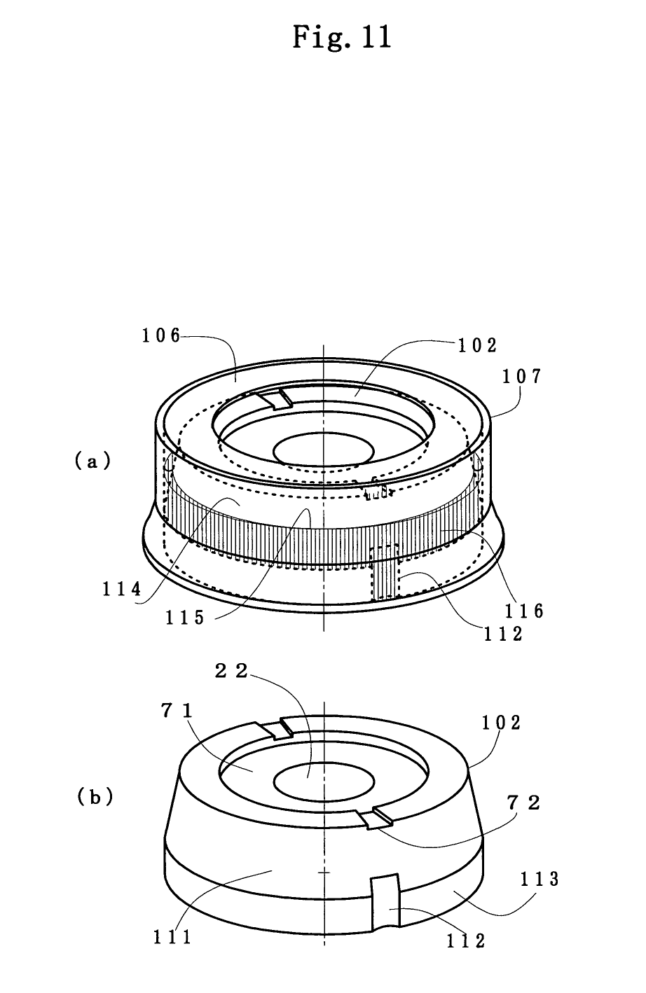

The second annular member specified in claim 1 corresponds to the flange 103 and a part of base plate 10g (hereinafter, referred to as an annular member 105). Numerals 106, 108 indicate a cover and a channel in the inner cylinder 102 respectively. The channel 108 is consisted as a gap between the inner cylinder 102 and the hub 107, detail structure is explained later referring FIG. 11. Numerals 10d, 107, 10e, 10f indicate a rotor magnet, a hub which supports recording disks, stator core, and coil respectively.

A lubricant is continuously filled into the gap between the shaft 101 and the inner cylinder 102, and the gap between the inner cylinder 102 and the first annular member 104, the flange 103, and the gap between the periphery of the inner cylinder 102 and the annular member 105. The interfaces of the lubricant with the air lie at outer region of the first annular member 104, in the channel 108 and on the periphery of the hub respectively.

The bearing grooves are composed of asymmetric herringbone grooves 109 formed on the inner surface of the inner cylinder 102 to have the upward pumping capability, asymmetric herringbone grooves 10a formed on the flange 103 to have the inward pumping capability, and pump-in spiral grooves 10b formed on the first annular member 104. The dimensional parameters of the grooves are set to make net lubricant flow continuously toward the periphery of the first annular member 104. During rotation, the asymmetric herringbone groove 10a increases the lubricant pressure between the flange 103 and the inner cylinder 102 to generate upward axial load capacity, and pump the lubricant toward the inner cylinder 102 top simultaneously.

The spiral groove 10b pumps the lubricant inwardly and the herringbone grooves 109, 10a pump the lubricant toward upper. The lubricant pressure between the inner cylinder 102 top and the first annular member 104 is increased to generate downward axial load capacity. The inner cylinder 102 is sustained at the position that both the downward and the upward axial load capacities balance. The asymmetric herringbone groove 109 generates radial load capacity to center the inner cylinder 102 to the shaft 101, but cannot generate enough moment for restoring the orientation of the rotating part when it tilts. This embodiment makes the asymmetric herringbone groove 10a generate the moment for restoring the orientation of the rotating part.

More specifically, when the rotating part tilts, the bottom end of the inner cylinder 102 also tilts to change the gap with the flange 103. In the vicinities of the areas where the gap varies in size, the asymmetric herringbone groove 10a increases the local pressure at its radial center by a degree inversely proportional to the gap. A moment for restoring the orientation of the rotating part occurs thus, and the orientation of the rotating part is restored.

FIG. 11 shows the inner cylinder 102, a part of the hub 107, and the cover 106 to constitute the channel 108 of the third embodiment. FIG. 11(b) shows a perspective view of the inner cylinder 102. FIG. 11(a) shows a perspective view of the combination of the inner cylinder 102, a part of the hub 107, and the cover 106.

The inner cylinder 102 shown in FIG. 11(b) has the concave groove 72 at its top. The numerals 22 represents a through hole in which the shaft 101 is fitted loosely, and the numeral 111 represents a cone surface that has enlarging diameter toward downward, and the numeral 112 represents the concave groove, and the numeral 113 represents the outer surface of the inner cylinder 102 besides the cone surface 111 and the concave groove 112. As shown in FIG. 11(a), the outer surface 113 of the inner cylinder 102 is fittingly fixed with inner surface of the hub 107, the cone surface 111 and the hub 107 constitute the gap diminishing region that the gap width is being smaller toward the bottom. A hatched area 116 shows the lubricant staying zone, numeral 114 shows air zone, numeral 115 shows the lubricant interface with the air.

The lubricant pressure adjuster employed in this embodiment is the diminishing gap in parallel with the axis 101. Radial thickness of the interface 115 region is so small that fluid pressure increase by the centrifugal force should be small. And also, the minimum gap width of the gap diminishing region can be around zero. Therefore surface tension force of the lubricant in the gap diminishing region is enough to retain the lubricant against the centrifugal force in the case of low profile HDD and low speed rotaion.

The first annular member 104 is fixed to the shaft 101 and perpedicularity between them should have some range in mass production. However, the present embodiment employs the spiral groove 10b on the first annular member 104. And the first annular member 104 can be smaller diameter to ease the perpendicularity specification. Adopting a herringbone groove instead of the spiral groove 10b, its contribution to the moment for restoring the orientation of the rotating part can be larger, but the diameter of the first annular member 104 should be larger.

Present embodiment causes net lubricant flow by pressure generating grooves 10a, 109, and 10b, then the lubricant is thrown out into the intake portion of the channel 108 by centrifugal force near the outer region of the first annular member 104. While the centrifugal force is small just after starting or just before stopping of the rotation, the asymmetric herringbone grooves 10a may have a lubricant pumping capability that is hard to be overlooked and may cause some undesirable disturbance in the flow of the lubricant.

The present embodiment has shallow pump-out spiral grooves 10c at a region inner than the region where the asymmetric herringbone grooves 10a lies. Depth of the spiral grooves 10c is set smaller than that of the asymmetric herringbone grooves 10a. The shallow pump-out spiral grooves 10c have strong outward lubricant pumping capability when the gap between the inner cylinder 102 and the flange 103 is small and then cancels the inward pumping capability of the asymmetric herringbone grooves 10a. The pumping capability of pressure generating grooves have optimum condition that depends on groove depth and gap ratio, the lubricant pumping capability becomes smaller when the ratio changes from the optimum condition.

The depth of the spiral grooves 10c is set as about 1 micron meter, the spiral grooves 10c reduce the lubricant pumping capability of the asymmetric herringbone grooves 10a just after starting or just before stopping of the rotation, and also contribute to lubicant pressure build up at the gap between the inner cylinder 102 and the flange 103. When the gap reaches several micron meters at predetermined rotational speed, the effect of the spiral groove 10c becomes significantly smaller.

The fixed shaft type fluid dynamic bearing motor with two thrust bearings at upper and lower sleeve ends, and the lubricant reservoir at outer periphery of the sleeve, has not succeeded the lubricant sealing. Present invention proved to realize reliable lubricant seal structure as shown by the first, the second, and the third embodiments. Present invention enables the fixed shaft type fluid dynamic bearing motor for low profile HDDs. And also present invention secure the radial bearing space maximum, then it can present minimum NRRO motor under the same motor thickness condition.

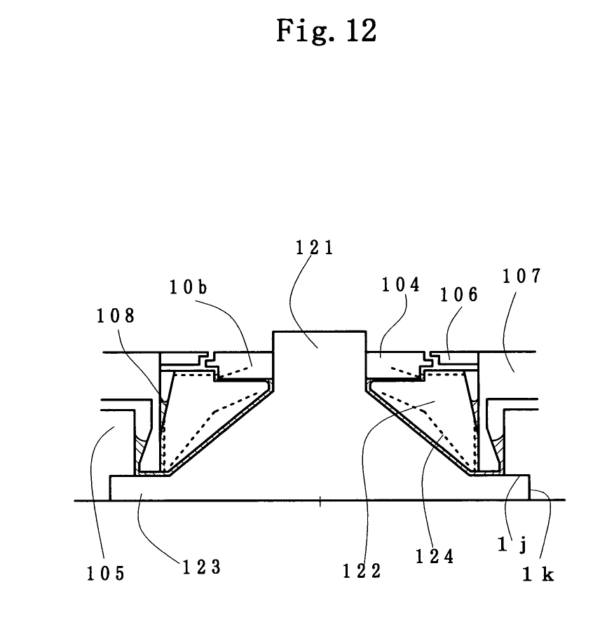

While the first, the second, and the third embodiments have dealt with an example of a cylindrical bearing, a fourth embodiment shown in FIG. 12 will deal with an example where the lubricant sealing structure of the present invention is applied to a conical shaft. The fourth embodiment shown in FIG. 12 is the bearing structure that replaced the groove 109 and the groove 10a in FIG. 10 by a bearing groove on the conical surface. Almost parts are common with the third embodiments shown in FIG. 10, same members will be designated by identical numerals. Description will thus be concentrated on differences from the third embodiment shown in FIG. 10.

A fixed shaft (hereinafter, referred to as a conical shaft 121 or a shaft 121) includes a truncated cone shape side wall diminishing its diameter toward an end of the shaft. A sleeve inner member 122 has an inner wall forming a conical concavity accommodating the shaft 121 and surrounding the side wall, the inner wall opposing the wall of the shaft 121 with a clearance. A flange 123 is fixed to the base plate, the sleeve is formed from the inner member 122 and a part of the hub 107 and has the channel 108 as their gap. The inner member 122 has an asymmetric herringbone groove 124, and the groove 124 pumps the lubricant toward the inner member 122 top during rotation. The lubricant is thrown out into the channel 108 at the outer region of the first annular member 104 by the centrifugal force.

The rotating part is supported at the position that the axial load capacity generated by the asymmetric herringbone groove 124 balances with the one generated by the asymmetric herringbone groove 124 and the spiral groove 10b during rotation. And also the rotating part should be centered to the shaft 121 by radial component of the load capacity generated by the asymmetric herringbone groove 124.

This embodiment has only a single series of asymmetric herringbone groove on the conical surface, and support the rotating part, and to achieve low non-repetitive runout during rotation. In this case, a fluid dynamic bearing motor of lower profile can be constructed. The structure of the bearing part and the principle of operation in case of a single herringbone groove formed in the conical surface are disclosed in detail in a U.S. Pat. No. 6,686,674 that is owned by the same applicant of the present application, and disclosure of the patent is incorporated herein by reference.

In this embodiment, the conical shaft 121 will be formed by molding and can reduce mass production cost, and is further suitable for low profile HDDs comparing the third embodiment.

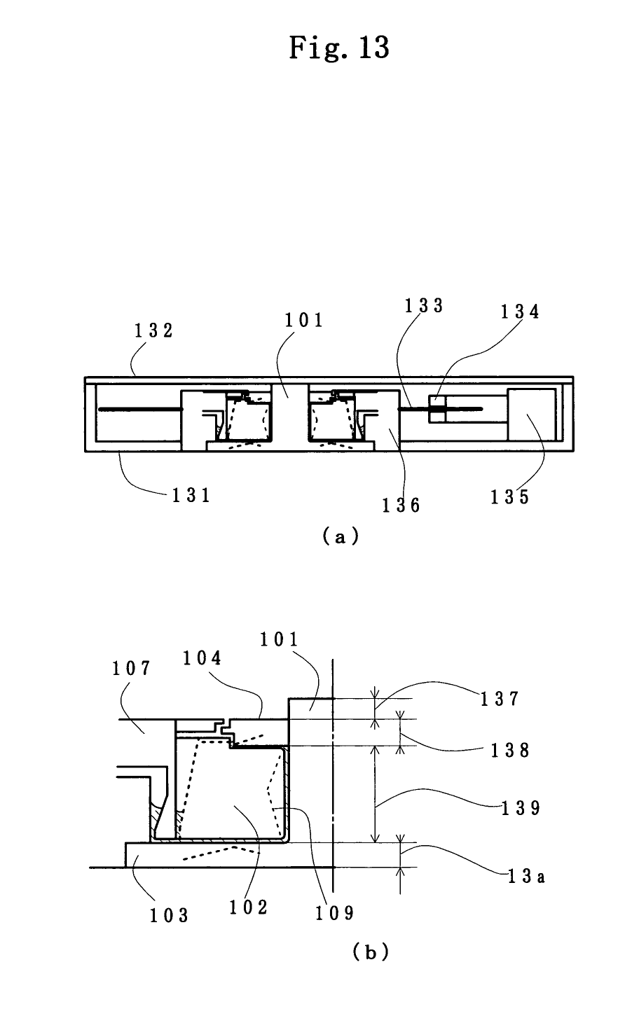

FIGS. 13(a) and 13(b) show an example of configuration of the low-profile HDD, the fifth embodiment which is formed by incorporating the third embodiment of the present invention, or the fluid dynamic bearing motor of the fixed shaft structure of FIG. 10.

The low-profile HDD shown in FIG. 13(a) has a fluid dynamic bearing motor 136 of fixed shaft structure which is formed on a case 131, or on the base plate 10g. A magnetic disk 133 is loaded on the motor 136. An actuator 135 for positioning a magnetic head 134 at a predetermined position on the magnetic disk 133 is provided. A cover 132 is fixed to the case 131. The shaft 101 makes contact with the cover 132 from below, thereby supporting the cover 132. None of electronic circuits and filter mechanisms for controlling the environment inside the HDD is shown.

In FIGS. 13(a) and 13(b), the fluid dynamic bearing motor 136 of fixed shaft structure is shown with the internal bearing alone. FIG. 13(b) shows an enlarged view. In the present embodiment, it is assumed that the magnetic disk has a diameter of 25 millimeters or so, and the low-profile HDD has a thickness of 2.5 millimeters or so.

Due to the limitation on the thickness of the HDD, bolts for fixing the shaft 101 to the cover 132 are omitted. The shaft 101 is used as a supporting column which makes contact with the cover 132 from inside, and avoids inward deformation of the cover 132. The numeral 137 designates the distance from the inside of the cover 132 to the annular member 104, the numeral 138 the axial thickness of the annular member 104, the numeral 139 the length of the sleeve 102, the numeral 13a the thickness of the flange 103, respectively.

Suppose here that the dimensions designated by the numerals 137 is set at 0.1 millimeters, the dimensions designated by the numerals 138 is set at 0.7 millimeters to secure the perpendicularity, and the dimension designated by the numeral 13a is set at 0.5 millimeters. The total thickness of the HDD of 2.5 millimeters then allows 1.0 millimeter for the effective length 139 of the radial bearing part considering 0.2 millimeters as the thickness of the cover 132.

Since it is enough to assign 1.0 millimeters or so to the herringbone grooves 109, the low-profile HDD having a thickness of 2.5 millimeters can be formed. The foregoing has shown that the fixed shaft type fluid dynamic bearing motor of the present invention is suited to achieving a low-profile HDD.

In the present invention, a new lubricant sealing method alternative to conventional tapered seals has been proposed, and the characteristics thereof have been described along with the principle of operation. The embodiments have dealt with application examples such as a cone bearing and a cylindrical bearing which have a straight bearing surface. In addition thereto, structures having a curved bearing surface are also applicable. Up to this point, the principle of operation and structure of the present invention have been described in conjunction with the embodiments.

The foregoing embodiments are no more than a few examples given for the sake of describing the principle of operation of the present invention, and it is understood that modifications may be made to the materials, structures, and the like without departing from the spirit of the present invention, and the foregoing description by no means limits the scope of the present invention.

The present application claims Convention priority based on Japanese patent applications 2004-240563, 2005-1089, 2005-20873, 2005-63232 of which disclosures are incorporated herein by reference.

What is claimed is:

1. A fluid dynamic bearing motor comprising:
a fixed shaft;
a rotary member including a sleeve which is rotatably fitted on the shaft with a small gap therebetween;
a first annular member fixedly provided to oppose a top end of the sleeve with a gap;
a second annular member fixedly provided to oppose a bottom end and a lower periphery of the sleeve with a gap;
a lubricant lying in the gaps between the sleeve and the shaft, and between the sleeve and the first annular member, and between the sleeve and the second annular member continuously, and having at least two interfaces with air near the upper region of the sleeve and on the lower portion of outer periphery of the sleeve; and
a channel formed in the sleeve and having an intake portion near the portion of the sleeve adjacent to the outer region of the first annular member and an outlet portion near the periphery of the bottom end of the sleeve, and the lubricant interface resides in the channel and the lubricant stays continuously from the outlet portion to the interface; and
at least two groups of dynamic pressure generating grooves for supporting the rotary member in a floated condition due to pressure partially increased in the lubricant by the grooves, one of the groups being formed on either of the upper surface of the sleeve and the first annular member and the other being formed on either of the inner surface of the sleeve and a surface confronting thereto; and
one of the groups of dynamic pressure generating grooves formed on either of the confronting surfaces of the sleeve and the shaft or the second annular member are asymmetric herringbone grooves or spiral grooves to pump lubricant upward toward the outer end of the first annular member, so that the lubricant is thrown out into the intake portion of the channel by centrifugal force near the outer region of the first annular member, and is conveyed from the intake portion to the outlet portion through the channel with the lubricant being discontinuous; and
lubricant pressure adjuster for adjusting the outward lubricant pressure occurring in the channel around the outlet portion of the channel and/or in the channel.

2. The fluid dynamic bearing motor according to claim 1, wherein
the lubricant pressure adjuster includes a dynamic-pressure generating groove that lies between the channel outlet and the fluid interface with air on the lower portion of outer periphery of the sleeve,
said dynamic-pressure generating groove being capable of pumping the lubiricant toward the outlet

3. The fluid dynamic bearing motor according to claim 1, wherein
the channel is slanted near the outlet in circumferential direction to push the lubricant towards an intake of the channel, thereby working as the lubricant pressure adjuster

4. The fluid dynamic bearing motor according to claim 1, wherein
the lubricant pressure adjuster has a structure that the gap between the sleeve and the annular member behind the channel outlet in rotaional direction is locally small to presse the lubricant into the channel outlet.

5. The fluid dynamic bearing motor according to claim 1, wherein
the lubricant pressure adjuster has a gap diminishing region in the channel that reduces its gap width towards the channel outlet.

6. The fluid dynamic bearing motor according to claim 5, wherein
the lubricant pressure adjuster has a gap diminishing region that is arranged in parallel with the shaft.

7. The fluid dynamic bearing motor according to claim 1, wherein:
quantity of lubricant to be pumped toward the top region of the sleeve surpasses quantity of lubricant that flows out from the thrust bearing region formed by the first annular member and the sleeve top by centrifugal force, thereby preventing air bubbles from entering into the periphery region of thrust bearing.

8. The fluid dynamic bearing motor according to claim 1, wherein:
a cross-sectional area of the intake opening of the channel in the sleeve is limited to make a fluid flow resistance high, with the lubricant to be flown from inner diameter region staying in the thrust bearing region.

9. The fluid dynamic bearing motor according to claim 1, wherein:
the channel has a step in a region from the intake to the thrust bearing region composed of the sleeve top and the first annular member,
the height of the step is larger than a gap between the sleeve top and the first annular member that is assumed during rotation of the sleeve,
whereby the lubricant to be flown from inner diameter region flows over the step and is thrown out into the channel.

10. The fluid dynamic bearing motor according to claim 1, wherein:
the fixed shaft has a cylindrical shape;
the sleeve has a cylindrical inner periphery, is rotatably fitted to the shaft, and is opposed to the first annular member at its top end orthogonal to the shaft, and is opposed to the second annular member at its bottom end orthogonal to the shaft;
dynamic-pressure generating grooves are formed in any one of the outer periphery of the shaft and the inner periphery of the sleeve, and any one of the first annular member and the top end of the sleeve, and any one of the second annular member and the bottom end of the sleeve, respectively; and
at least the dynamic-pressure generating grooves formed in either the bottom end of the sleeve or the opposed surface thereof is formed as any one of an asymmetric herringbone groove and a spiral groove having a radially inward lubricant pumping capability.

11. The fluid dynamic bearing motor according to claim 10, wherein:
one group of herringbone grooves are formed on any one of the opposed surfaces of the cylindrical shaft and the inner periphery of the sleeve; and
a group of spiral grooves having the capability of pumping the lubricant radially inward is formed on any one of the opposed surfaces of the first annular member and the top end of the sleeve; and
a group of asymmetric herringbone grooves having the capability of pumping the lubricant radially inward is formed on any one of the opposed surfaces of the second annular member and the bottom end of the sleeve.

12. The fluid dynamic bearing motor according to claim 10, wherein:
two groups of asymmetric herringbone grooves having capability of pumping lubricant toward the first and second annular member which are adjacent to respective groups of asymmetric herringbone groups are formed on any one of the opposed surfaces of the cylindrical shaft and the inner periphery of the sleeve;
a group of pump-in spiral groove is formed on any one of the opposed surfaces of the first annular member and the top end of the sleeve;
a group of pump-in spiral groove is formed on any one of the opposed surfaces of the annular member and the bottom end of the sleeve; and
net fluid pumping capability of said four groups of grooves makes the lubricant flow continuously toward the outer region of the first annular member, and in each combination of the group of asymmetric herringbone grooves and the group of spiral grooves adjacent thereto, each group of grooves pushes the lubricant toward the other group of grooves of the same combination and increases the lubricant pressure to support the rotating member without the rotating member being contacted.

13. The fluid dynamic bearing motor according to claim 10, wherein
a portion of the cylindrical shaft and a flange confronting to the bottom end of the sleeve are integrated into a T-shaped shaft, and a radial side of the flange exercises positional regulation while the periphery of the surface confronting to the bottom end of the sleeve and a part of a base plate are opposed and fixed in the axial direction.

14. The fluid dynamic bearing motor according to claim 1, wherein:
the fixed shaft has a conical convex outer wall narrowing toward the top end;
the sleeve has a conical concave inner wall to fit on the outer wall of the shaft;
one or more dynamic-pressure generating grooves are formed between the shaft and the sleeve; and
at least one of the above dynamic-pressure generating grooves has capability of pumping lubricant toward the top end of the sleeve; and
a pump-in spiral groove or a herringbone groove is formed on any one of the opposed surfaces of the first annular member and the top end of the sleeve.

15. A low-profile recording disk drive including the fluid dynamic bearing motor as claimed in claim 1, the disk drive comprising:
a housing;
a recording disk;
the fluid dynamic motor being adapted for rotating the recording disk loaded thereon; and
data access means for writing or reading data to/from a predetermined position on the recording disk,
wherein the fixed shaft of the fluid dynamic bearing motor functions as a pillar to support the housing at the center.

16. A method of controlling a lubricant in a fluid dynamic bearing motor having a sleeve rotatably fitted on a fixed shaft and lubricant filled in a gap between the shaft and the sleeve, with interfaces of the lubricant with air being close to periphery of thrust bearing at the top of the sleeve and around a lower part of the sleeve, the method comprising:
pumping and conveying the lubricant existing between the sleeve and the shaft, toward an outer region of the sleeve top end by asymmetric herringbone grooves or spiral grooves formed on either of confronting surfaces of the sleeve and the shaft while the sleeve is rotating;
throwing by centrifugal force the conveyed lubricant into an intake portion of a channel having the intake portion near the outer region of the thrust bearing at the sleeve top end, the channel extending from the intake portion to an outlet portion formed near the periphery of the bottom end of the sleeve; and
conveying the lubricant from the intake portion to the outlet portion by centrifugal force and/or through a slanted channel in circumferential direction through the channel with the lubricating fluid being discontinuous.
